(19) United States
(12) Patent Application Publication
(10) Pub. No.: US 2026/0056431 A1
(43) Pub. Date: Feb. 26, 2026

(54) ARRAY SUBSTRATE AND DISPLAY DEVICE

(71) Applicant: HANNSTAR DISPLAY CORPORATION, Taipei City (TW)

(72) Inventors: Shao-Chien Chang, Taoyuan City (TW); Cheng-Yen Yeh, Taichung City (TW); Ling-Chih Kao, New Taipei City (TW); Ying-Jung Chen, New Taipei City (TW); Jing-Ya Chiu, Tainan City (TW); Qi-En Luo, Chiayi County (TW)

(73) Assignee: HANNSTAR DISPLAY CORPORATION, Taipei City (TW)

(21) Appl. No.: 18/938,303

(22) Filed: Nov. 6, 2024

(30) Foreign Application Priority Data
Aug. 26, 2024 (TW) 113131960

(51) Int. Cl. G02F 1/1335

(52) U.S. Cl. CPC G02F 1/133553; G02F 2203/09

(57) ABSTRACT

An array substrate includes a plurality of sub-pixel structures disposed on a first substrate and including a first sub-pixel structure, a second sub-pixel structure and a third sub-pixel structure. The first sub-pixel structure has a first center and includes a first reflecting region and at least one first penetrating region. The second sub-pixel structure has a second center and includes a second reflecting region. The third sub-pixel structure has a third center and includes a third reflecting region. The first sub-pixel structure, the second sub-pixel structure and the third sub-pixel structure are adjacent to each other and display different colors. The first center, the second center and the third center form a triangle in a top view. At least two of a geometric shape of the first sub-pixel structure, a geometric shape of the first reflecting region and a geometric shape of the first penetrating region are not quadrilaterals.

### BACKGROUND OF THE INVENTION

### 1. Field of the Invention

The present invention relates to an array substrate and a display device, and more particularly, to an array substrate and a display device having high display quality.

### 2. Description of the Prior Art

Nowadays, electronic devices have become an indispensable item. Since a display device having a display function has the characteristics of thin appearance, light weight, low power consumption and no radiation pollution, it has been widely used in many kinds of electronic products, such as notebooks, smart phones, portable devices, smart watches, and display devices in vehicles, for transmitting and displaying information more conveniently. In the display device, the design of display units (e.g., pixels or sub-pixels) configured to display an image would highly affect the display quality of the display device (e.g., sizes of the display units, tightness of the display units or other design would highly affect the display quality of the display device). Therefore, the industry is committed to appropriately adjusting and designing the display units to improve the display quality of the display device.

### SUMMARY OF THE INVENTION

It is therefore a primary objective of the present invention to provide an array substrate, wherein tightness of sub-pixel structures of the array substrate is increased by appropriately designing shapes of the sub-pixel structures, thereby improving a display quality related to the array substrate. The present invention further provides a display device including this array substrate.

In order to solve the above technical problems, the present invention provides an array substrate including a first substrate and a plurality of sub-pixel structures. The sub-pixel structures are disposed on the first substrate, wherein the sub-pixel structures include a first sub-pixel structure, a second sub-pixel structure and a third sub-pixel structure. The first sub-pixel structure has a first center and includes a first reflecting region and at least one first penetrating region. The second sub-pixel structure has a second center and includes a second reflecting region. The third sub-pixel structure has a third center and includes a third reflecting region. The first sub-pixel structure, the second sub-pixel structure and the third sub-pixel structure are adjacent to each other and display different colors, and the first center, the second center and the third center form a triangle in a top view. At least two of a geometric shape of the first sub-pixel structure, a geometric shape of the first reflecting region and a geometric shape of the first penetrating region are not quadrilaterals. The present invention further provides a display device including aforementioned array substrate, an opposite substrate opposite to the aforementioned array substrate and a display medium layer disposed between the aforementioned array substrate and the opposite substrate.

### BRIEF DESCRIPTION OF THE DRAWINGS

FIG. 1 is a schematic diagram of a top view illustrating sub-pixel structures of a display device according to a first embodiment of the present invention.

FIG. 2 is a schematic diagram of a cross-sectional view of a structure taken along a cross-sectional line A-A′ in FIG. 1.

FIG. 3 is a schematic diagram of a top view illustrating sub-pixel structures of a display device according to a second embodiment of the present invention.

FIG. 4 is a schematic diagram of a cross-sectional view illustrating a display device according to a third embodiment of the present invention.

### DETAILED DESCRIPTION

To provide a better understanding of the present invention to those skilled in the art, preferred embodiments and typical material or range parameters for key components will be detailed in the follow description. These preferred embodiments of the present invention are illustrated in the accompanying drawings with numbered elements to elaborate on the contents and effects to be achieved. It should be noted that the drawings are simplified schematics, and the material and parameter ranges of key components are illustrative based on the present day technology, and therefore show only the components and combinations associated with the present invention, so as to provide a clearer description for the basic structure, implementing or operation method of the present invention. The components would be more complex in reality and the ranges of parameters or material used may evolve as technology progresses in the future. In addition, for ease of explanation, the components shown in the drawings may not represent their actual number, shape, and dimensions; details may be adjusted according to design requirements.

In the following description and in the claims, the terms “include”, “comprise” and “have” are used in an open-ended fashion, and thus should be interpreted to mean “include, but not limited to . . . ”. Thus, when the terms “include”, “comprise” and/or “have” are used in the description of the present invention, the corresponding features, areas, steps, operations and/or components would be pointed to existence, but not limited to the existence of one or a plurality of the corresponding features, areas, steps, operations and/or components.

In the following description and in the claims, when “a A1 component is formed by/of B1”, B1 exist in the formation of A1 component or B1 is used in the formation of A1 component, and the existence and use of one or a plurality of other features, areas, steps, operations and/or components are not excluded in the formation of A1 component.

In the description and following claims, the term “horizontal direction” generally means a direction parallel to a horizontal plane, the term “horizontal plane” generally means a surface parallel to a direction X and a direction Y in the drawings (i.e., the direction X and the direction Y of the present invention may be considered as the horizontal directions), the term “vertical direction” and the term “top-view direction” generally mean a direction parallel to a direction Z and perpendicular to the horizontal direction in the drawings, and the direction X, the direction Y and the direction Z are perpendicular to each other. In the description and following claims, the term “top view” generally means a viewing result viewing along the vertical direction. In the description and following claims, the term “top view” generally means a viewing result viewing along the vertical direction. In the description and following claims, the term “cross-sectional view” generally means a structure cut along the vertical direction is viewed along the horizontal direction.

In the description and following claims, the term “overlap” means that two elements overlap along the direction Z, and the term “overlap” may be “partially overlap” or “completely overlap” in unspecified circumstances, wherein when two elements overlap along the direction Z, these two elements may be directly in contact with each other in the direction Z, or an intervening component exists between these two elements in the direction Z.

Although terms such as first, second, third, etc., may be used to describe diverse constituent elements, such constituent elements are not limited by the terms. The terms are used only to discriminate a constituent element from other constituent elements in the specification, and the terms do not relate to the sequence of the manufacture if the specification do not describe. The claims may not use the same terms, but instead may use the terms first, second, third, etc. with respect to the order in which an element is claimed. Accordingly, in the following description, a first constituent element may be a second constituent element in a claim.

It should be noted that the technical features in different embodiments described in the following can be replaced, recombined, or mixed with one another to constitute another embodiment without departing from the spirit of the present invention.

In the present invention, the display device may be any suitable display. In some embodiments, the display device may be a display that displays an image by reflecting external light (e.g., external white light).

The display device may include a display panel, and the display panel may use an external light for displaying. The external light enters the display panel from a side of the display panel facing to a user, and the display panel reflects the external light to display an image. In some embodiments, the aforementioned external light may be an ambient light (e.g., a solar light), but not limited thereto. For instance, the display panel may be a transflective display panel, such that the display device may be a transflective display, wherein the transflective display further includes a backlight module disposed on a side of the transflective display panel facing away from the user, and the transflective display panel uses not only the aforementioned external light but also a backlight provided from the backlight module for displaying, but not limited thereto.

A display region of the display device may include a plurality of pixels serving as units for displaying, wherein the pixel may include at least one sub-pixel. In some embodiments, if the display device is a color display, one pixel may include a plurality of sub-pixels (e.g., a green sub-pixel, a red sub-pixel and a blue sub-pixel), but not limited thereto. The number and color(s) of the sub-pixel(s) included in one pixel may be adjusted based on requirement(s). In some embodiments, if the display device is a monochrome display, one pixel may include only one sub-pixel, but not limited thereto.

In the following, the display device is a transflective color display for instance.

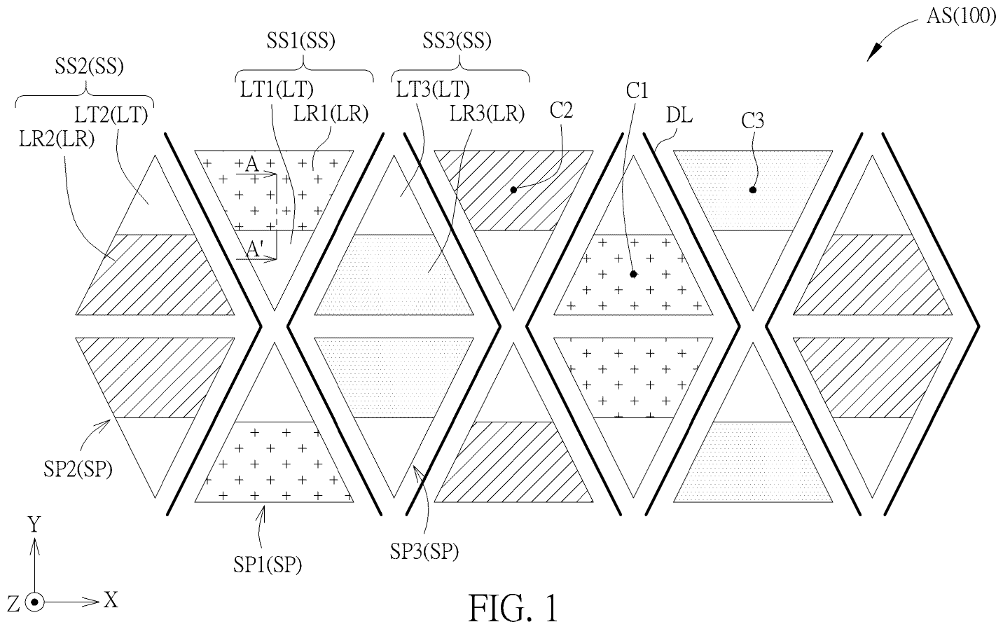

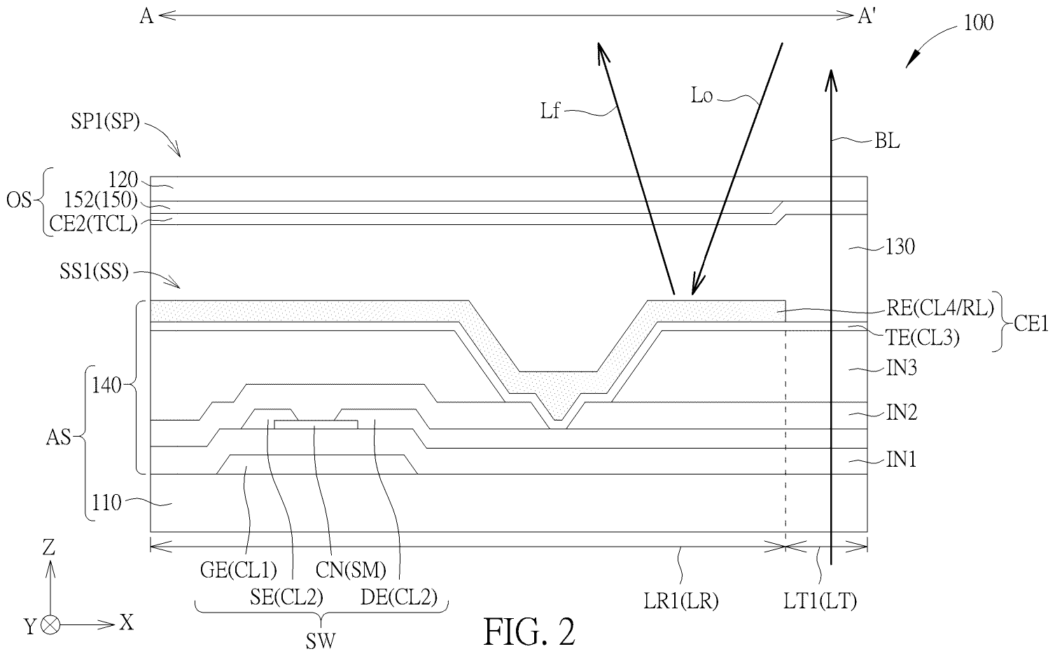

Referring to FIG. 1 and FIG. 2, FIG. 1 is a schematic diagram of a top view illustrating sub-pixel structures of a display device according to a first embodiment of the present invention, and FIG. 2 is a schematic diagram of a cross-sectional view of a structure taken along a cross-sectional line A-A′ in FIG. 1. As shown in FIG. 1 and FIG. 2, the display device 100 (or the display panel of the display device 100) may include a first substrate 110 and a second substrate 120 opposite to the first substrate 110. The first substrate 110 and the second substrate 120 may have the same material or different materials, and the first substrate 110 and the second substrate 120 may be rigid or flexible individually. Based on the type of the first substrate 110 and the type of the second substrate 120, the first substrate 110 and the second substrate 120 may individually include glass, plastic, quartz, sapphire, polymer (e.g., polyimide (PI), polyethylene terephthalate (PET), etc.), other suitable materials or a combination thereof, but not limited thereto. In addition, a shape and a size of the first substrate 110 and a shape and a size of the second substrate 120 may be designed based on requirement(s). Note that a normal direction of the first substrate 110 and a normal direction of the second substrate 120 may be parallel to the direction Z.

As shown in FIG. 1 and FIG. 2, the display device 100 (or the display panel of the display device 100) may include a display medium layer 130 disposed between the first substrate 110 and the second substrate 120. The display medium layer 130 may include any suitable material according to the type of the display device 100. In this embodiment, the display medium layer 130 may include liquid crystal molecules, electrophoretic material or other suitable display medium material, but not limited thereto. The display medium material included in the display medium layer 130 may be adjusted by any suitable method, so as to adjust the status of a part of the display medium layer 130 corresponding to the sub-pixel SP, thereby be combined with the function of a polarizer of the display device 100 to correspondingly adjust the light transmittance of this sub-pixel SP. For instance, in some embodiments, the status of the display medium layer 130 may be controlled by an electric field (e.g., an electric field generated between a pixel electrode and a common electrode) and/or at least one electrical signal.

In the present invention, electrode(s) configured to control the status of the display medium layer 130 may be designed based on requirement(s). For instance (as shown in FIG. 2), a first controlling electrode CE1 (e.g., the pixel electrode) and a second controlling electrode CE2 (e.g., the common electrode) configured to control the display medium layer 130 may be disposed on opposite sides of the display medium layer 130 (i.e., the display medium layer 130 may be between the first controlling electrode CE1 and the second controlling electrode CE2 in the direction Z), wherein the first controlling electrode CE1 may be disposed between the first substrate 110 and the display medium layer 130, the second controlling electrode CE2 may be disposed between the second substrate 120 and the display medium layer 130, but not limited thereto. For instance (not shown in figures), the first controlling electrode CE1 and the second controlling electrode CE2 configured to control the display medium layer 130 may be disposed on the same side of the display medium layer 130, wherein the first controlling electrode CE1 and the second controlling electrode CE2 may be disposed between the first substrate 110 and the display medium layer 130, but not limited thereto. Each sub-pixel SP may include the first controlling electrode CE1 and the second controlling electrode CE2, so as to make the status of a part of the display medium layer 130 corresponding to the sub-pixel SP be adjusted according to the electrical signals (e.g., the gray level signal) received by the first controlling electrode CE1 and/or the second controlling electrode CE2, thereby adjusting the light transmittance of the sub-pixel SP, but not limited thereto.

In the present invention, the display device 100 (or the display panel of the display device 100) may include a plurality of sub-pixel structures SS disposed between the first substrate 110 and the display medium layer 130 (i.e., the sub-pixel structure SS is disposed on the first substrate 110), wherein the sub-pixel structure SS may be disposed in the sub-pixel SP, and each sub-pixel SP may have one sub-pixel structure SS. In the sub-pixel SP of the display device 100, electronic components disposed between the first substrate 110 and the display medium layer 130 may be disposed in the sub-pixel structures SS. In some embodiments (as shown in FIG. 2), if the first controlling electrode CE1 (e.g., the pixel electrode) and the second controlling electrode CE2 (e.g., the common electrode) are disposed on opposite sides of the display medium layer 130, the first controlling electrode CE1 may be included in the sub-pixel structure SS disposed between the first substrate 110 and the display medium layer 130, and the second controlling electrode CE2 may be included in a transparent conductive layer TCL disposed between the second substrate 120 and the display medium layer 130. In some embodiments (not shown in figures), if the first controlling electrode CE1 and the second controlling electrode CE2 are disposed on the same side of the display medium layer 130, the first controlling electrode CE1 and the second controlling electrode CE2 may be included in the sub-pixel structure SS disposed between the first substrate 110 and the display medium layer 130.

The sub-pixel structure SS may further include other required electronic component(s) to form a suitable circuit. For instance, the sub-pixel structure SS may include a switching component SW electrically connected to the first controlling electrode CE1, so as to make the sub-pixel structure SS have a suitable sub-pixel circuit. For example, the switching component SW may be a top gate thin film transistor, a bottom gate thin film transistor, a dual gate thin film transistor or other suitable switching component (in FIG. 2, the switching component SW is a bottom gate thin film transistor for example). Note that a number of the switching component(s) SW included in one sub-pixel structure SS may be designed based on requirement(s).

As shown in FIG. 2, the display device 100 (or the display panel of the display device 100) may include a circuit component layer 140 disposed between the first substrate 110 and the display medium layer 130, wherein the circuit component layer 140 may form the electronic components (e.g., the switching component SW and the first controlling electrode CE1) and the circuit of the sub-pixel structure SS. In the present invention, the circuit component layer 140 may include at least one conductive layer, at least one insulating layer, at least one semiconductor layer or a combination thereof, so as to form the electronic components and the circuit. The material of the conductive layer may include such as metal, transparent conductive material (such as indium tin oxide (ITO), indium zinc oxide (IZO), etc.), other suitable conductive material(s) or a combination thereof, but not limited thereto. The material of the insulating layer may include such as inorganic insulating material (e.g., silicon oxide (SiOₓ), silicon nitride (SiN_{y}), silicon oxynitride (SiOₓN_{y})), organic insulating material (e.g., photosensitive resin), other suitable insulating material(s) or a combination thereof, but not limited thereto. The material of the semiconductor layer may include such as poly-silicon, amorphous silicon, metal-oxide semiconductor, other suitable semiconductor material(s) or a combination thereof, but not limited thereto.

In the circuit component layer 140 of the present invention, a number of the conductive layer(s), a number of the insulating layer(s), a number of the semiconductor layer(s) and the stacking order of these layers may be adjusted according to the type of the electronic component and the circuit design. For instance, in FIG. 2, the circuit component layer 140 may include a conductive layer CL1, an insulating layer IN1, a semiconductor layer SM, a conductive layer CL2, an insulating layer IN2, an insulating layer IN3, a conductive layer CL3 and a conductive layer CL4 stacked on the first substrate 110 in sequence, but not limited thereto.

For instance (as shown in FIG. 2), if the switching component SW is the bottom gate thin film transistor, a gate electrode GE of the switching component SW may be included in the conductive layer CL1, a gate insulating layer of the switching component SW may be included in the insulating layer IN1, a source electrode SE and a drain electrode DE of the switching component SW may be included in the conductive layer CL2, and a channel layer CN of the switching component SW may be included in the semiconductor layer SM, but not limited thereto. For instance (as shown in FIG. 2), the conductive layer CL1 and the conductive layer CL2 may be a layer with high conductivity (e.g., a metal layer), but not limited thereto.

The first controlling electrode CE1 (e.g., the pixel electrode) may be formed of one layer or a plurality of layers in the circuit component layer 140. For instance (as shown in FIG. 2), the first controlling electrode CE1 may be included in the conductive layer CL3 and/or the conductive layer CL4. For instance (as shown in FIG. 2), the conductive layer CL3 may be a transparent conductive layer including the transparent conductive material, and the conductive layer CL4 may be a layer with high conductivity and high light-reflectivity (e.g., a metal layer), but not limited thereto.

In the present invention, since the display device 100 may display an image by reflecting the external light Lo, the display device 100 (or the display panel of the display device 100) may include a light reflective layer RL configured to reflect the external light Lo and disposed between the first substrate 110 and the display medium layer 130, such that the display device 100 may be able to display an image through the light reflected by the light reflective layer RL. In some embodiments, the light reflective layer RL may be included in the circuit component layer 140 and included in the sub-pixel structure SS. In the present invention, the material of the light reflective layer RL may make the light reflective layer RL have light-reflectivity and other needed requirement(s). In some embodiments, the light reflective layer RL may include a metal layer to make the light reflective layer RL have the high light-reflectivity. For instance, the light reflective layer RL may include metal material with high light-reflectivity, such as silver, aluminum, other suitable metal material or a combination thereof, but not limited thereto.

In some embodiments (as shown in FIG. 2), if the first controlling electrode CE1 (e.g., the pixel electrode) and the second controlling electrode CE2 (e.g., the common electrode) are disposed on opposite sides of the display medium layer 130, the first controlling electrode CE1 may be included in the light reflective layer RL, but not limited thereto. In some embodiments (not shown in figures), if the first controlling electrode CE1 and the second controlling electrode CE2 are disposed on the same side of the display medium layer 130, the first controlling electrode CE1 and/or the second controlling electrode CE2 may be included in the light reflective layer RL, but not limited thereto. In some embodiments (not shown in figures), the conductive layer including the first controlling electrode CE1 and the conductive layer including the second controlling electrode CE2 may be different from the light reflective layer RL.

For instance, in FIG. 2, the conductive layer CL4 may serve as the light reflective layer RL, and the first controlling electrode CE1 (e.g., the pixel electrode) may be formed of the conductive layer CL3 and the conductive layer CL4 (i.e., a portion of the first controlling electrode CE1 may be included in the light reflective layer RL), but not limited thereto. A portion of the first controlling electrode CE1 formed of the conductive layer CL3 may serve as a penetrated electrode TE, and another portion of the first controlling electrode CE1 formed of the conductive layer CL4 may serve as a reflecting electrode RE (i.e., the first controlling electrode CE1 may include the penetrated electrode TE and the reflecting electrode RE).

In the present invention, the sub-pixel structure SS may have a reflecting region LR, and the sub-pixel structure SS may optionally have at least one penetrated region LT according to the type of the corresponding sub-pixel SP, wherein the reflecting region LR in the sub-pixel structure SS may be configured to reflect the external light Lo, the backlight BL provided from the backlight module may pass through the penetrated region LT in the sub-pixel structure SS, and the existence of the penetrated region LT may increase the brightness of the display image. In the present invention, the arrangement of the first controlling electrode CE1 (e.g., the pixel electrode) may be designed based on the reflecting region LR and the penetrated region LT. In some embodiments (as shown in FIG. 1 and FIG. 2), the first controlling electrode CE1 may be formed of the conductive layer CL3 and the conductive layer CL4, the reflecting electrode RE of the first controlling electrode CE1 (i.e., a portion of the first controlling electrode CE1 formed of the conductive layer CL4) may be disposed in the reflecting region LR and not be disposed in the penetrated region LT, and the penetrated electrode TE of the first controlling electrode CE1 (i.e., a portion of the first controlling electrode CE1 formed of the conductive layer CL3) may be disposed in the penetrated region LT at least (i.e., at least a portion of the pixel electrode may be disposed in the penetrated region LT), such that the display medium layer 130 in the reflecting region LR and the display medium layer 130 in the penetrated region LT may be controlled by the first controlling electrode CE1, and the reflecting region LR and the penetrated region LT respectively have corresponding optical effects. For instance, in FIG. 2, the penetrated electrode TE may be disposed in the reflecting region LR and the penetrated region LT, and the reflecting electrode RE may be only disposed in the reflecting region LR (i.e., the first controlling electrode CE1 in the reflecting region LR may be formed of the conductive layer CL3 and the conductive layer CL4, and the first controlling electrode CE1 in the penetrated region LT may be formed of the conductive layer CL3), but not limited thereto. For instance, in FIG. 2, the boundaries of the reflecting region LR may be defined by the reflecting electrode RE, and the boundaries of the penetrated region LT may be defined by the reflecting electrode RE and the penetrated electrode TE, but not limited thereto. In FIG. 2, the switching component SW may be disposed in the reflecting region LR and overlap the reflecting electrode RE.

In the present invention, the sub-pixel structure SS may be correspondingly designed based on the type of the corresponding sub-pixel SP. In detail, as shown in FIG. 1 and FIG. 2, since the display device 100 is a color display, the sub-pixel structures SS may include a first sub-pixel structure SS1, a second sub-pixel structure SS2 and a third sub-pixel structure SS3 respectively belonging to the sub-pixels SP displaying different colors (i.e., the first sub-pixel structure SS1, the second sub-pixel structure SS2 and the third sub-pixel structure SS3 may be configured to display different colors), and the first sub-pixel structure SS1, the second sub-pixel structure SS2 and the third sub-pixel structure SS3 are adjacent to each other. For instance, the first sub-pixel structure SS1 may be disposed in a green sub-pixel SP1, the second sub-pixel structure SS2 may be disposed in a red sub-pixel SP2, the third sub-pixel structure SS3 may be disposed in a blue sub-pixel SP3, and the first sub-pixel structure SS1 may be disposed between the second sub-pixel structure SS2 and the third sub-pixel structure SS3, but not limited thereto.

In the present invention, the first sub-pixel structure SS1 may have a first reflecting region LR1 and optionally have at least one first penetrating region LT1, the second sub-pixel structure SS2 may have a second reflecting region LR2 and optionally have at least one second penetrating region LT2, and the third sub-pixel structure SS3 may have a third reflecting region LR3 and optionally have at least one third penetrating region LT3. In the present invention, the presence or absence of the penetrated region LT in the sub-pixel structure SS and the number of the penetrated region(s) LT in the sub-pixel structure SS may be designed based on the type of the corresponding sub-pixel SP and/or other requirement(s). For instance (as shown in FIG. 1), the first sub-pixel structure SS1 may have one first reflecting region LR1 and one first penetrating region LT1 and correspondingly include a first reflecting electrode disposed in the first reflecting region LR1 (i.e., the reflecting electrode RE in the first sub-pixel structure SS1) and a first penetrated electrode disposed in the first reflecting region LR1 and the first penetrating region LT1 (i.e., the penetrated electrode TE in the first sub-pixel structure SS1); the second sub-pixel structure SS2 may have one second reflecting region LR2 and one second penetrating region LT2 and correspondingly include a second reflecting electrode disposed in the second reflecting region LR2 (i.e., the reflecting electrode RE in the second sub-pixel structure SS2) and a second penetrated electrode disposed in the second reflecting region LR2 and the second penetrating region LT2 (i.e., the penetrated electrode TE in the second sub-pixel structure SS2); the third sub-pixel structure SS3 may have one third reflecting region LR3 and one third penetrating region LT3 and correspondingly include a third reflecting electrode disposed in the third reflecting region LR3 (i.e., the reflecting electrode RE in the third sub-pixel structure SS3) and a third penetrated electrode disposed in the third reflecting region LR3 and the third penetrating region LT3 (the penetrated electrode TE in the third sub-pixel structure SS3), but not limited thereto. For instance (not shown in figures), the first sub-pixel structure SS1 may have the first reflecting region LR1 and the first penetrating region LT1, the second sub-pixel structure SS2 may have the second reflecting region LR2 and the second penetrating region LT2, and the third sub-pixel structure SS3 may have the third reflecting region LR3 and not have the third penetrating region LT3, but not limited thereto.

In the present invention, the tightness of the sub-pixel structures SS may be enhanced by appropriately designing geometric shapes of the sub-pixel structures SS, geometric shapes of the reflecting regions LR and geometric shapes of the penetrated regions LT in the top view, and the display quality may be enhanced as the tightness of the sub-pixel structures SS is enhanced. In each sub-pixel structure SS, in the top view, at least two of the geometric shape of the sub-pixel structure SS, the geometric shape of the reflecting region LR and the geometric shape of the penetrated region LT are not quadrilaterals. In some embodiments (as shown in FIG. 1), two of the geometric shape of the sub-pixel structure SS, the geometric shape of the reflecting region LR and the geometric shape of the penetrated region LT are not quadrilaterals, and another one of the geometric shape of the sub-pixel structure SS, the geometric shape of the reflecting region LR and the geometric shape of the penetrated region LT is a quadrilateral and is not a rectangle, but not limited thereto. In some embodiments (not shown in figures), the geometric shape of the sub-pixel structure SS, the geometric shape of the reflecting region LR and the geometric shape of the penetrated region LT are not quadrilaterals, but not limited thereto.

In the present invention, the geometric shape of the sub-pixel structure SS, the geometric shape of the reflecting region LR and the geometric shape of the penetrated region LT in the top view may be any suitable shape, and the geometric shape of the sub-pixel structure SS, the geometric shape of the reflecting region LR and the geometric shape of the penetrated region LT in the top view may be the same or different. In some embodiments, the geometric shape of the sub-pixel structure SS, the geometric shape of the reflecting region LR and the geometric shape of the penetrated region LT in the top view may have symmetrical axes and be line-symmetrical shapes, but not limited thereto. For instance, the geometric shape of the sub-pixel structure SS may be a triangle, a quadrilateral or a hexagon, the geometric shape of the reflecting region LR may be a triangle, a quadrilateral or a hexagon, and the geometric shape of the penetrated region LT may be a triangle, a quadrilateral or a hexagon, wherein these quadrilaterals do not rectangles (e.g., the quadrilaterals may be trapezoids, rhombuses, etc.), but not limited thereto. For instance, in FIG. 1, the geometric shape of the sub-pixel structure SS may be a triangle, the geometric shape of the reflecting region LR may be a trapezoid, and the geometric shape of the penetrated region LT may be a triangle, but not limited thereto.

In the present invention, the sub-pixel structures SS may be arranged based on requirement(s). In FIG. 1, the sub-pixel structures SS may be arranged into a plurality of rows extending in the direction X and a plurality of columns extending in the direction Y, and the geometric shapes of two adjacent sub-pixel structures SS (i.e., two sub-pixel structures SS closest to each other) may be opposite in the top view. For instance, different types of sub-pixel structures SS (the first sub-pixel structure SS1, the second sub-pixel structure SS2 and the third sub-pixel structure SS3) may be alternately arranged in one row, and the same type of sub-pixel structures SS may be arranged in one column, but not limited thereto.

Also, since the geometric shapes of two adjacent sub-pixel structures SS are opposite in the top view, in one pixel, a first center C1 of the first sub-pixel structure SS1, a second center C2 of the second sub-pixel structure SS2 and a third center C3 of the third sub-pixel structure SS3 form a triangle in the top view (i.e., the first center C1, the second center C2 and the third center C3 are three vertices of a triangle), such that the first sub-pixel structure SS1, the second sub-pixel structure SS2 and the third sub-pixel structure SS3 are arranged in a triangular manner, so as to increase the tightness of the sub-pixel structures SS, thereby enhancing the display quality.

Furthermore, in the sub-pixel structure SS, the positions of the reflecting region LR and the penetrated region LT may be designed based on requirement(s). In FIG. 1, the penetrated region LT and the reflecting region LR may be arranged in the direction Y. For instance, in FIG. 1, the geometric shape of the sub-pixel structure SS may be a triangle and have three vertices, wherein two vertices of the sub-pixel structure SS may be situated in the reflecting region LR, and another one vertex of the sub-pixel structure SS may be situated in the penetrated region LT, but not limited thereto. In addition, since the geometric shapes of two adjacent sub-pixel structures SS are opposite in the top view, the relation of the reflecting region LR and the penetrated region LT in one of two adjacent sub-pixel structures SS is opposite to the relation of the reflecting region LR and the penetrated region LT in another one of two adjacent sub-pixel structures SS. For instance, in FIG. 1, the second penetrating region LT2, the first reflecting region LR1 and the third penetrating region LT3 may be arranged in the direction X, and the second reflecting region LR2, the first penetrating region LT1 and the third reflecting region LR3 may be arranged in the direction X, but not limited thereto.

In one sub-pixel structure SS, a ratio of an area of the reflecting region LR to an area of the sub-pixel structure SS and a ratio of an area of the penetrated region LT to the area of the sub-pixel structure SS may be designed based on requirement(s). For instance, a ratio of the area of the penetrated region LT to the area of the sub-pixel structure SS may be greater than 0 and less than or equal to 0.55, but not limited thereto. Moreover, the areas of the penetrated regions LT of the sub-pixel structures SS corresponding to different types of sub-pixels SP may be the same or different. For instance, an area of the first penetrating region LT1 may be greater than or equal to an area of the second penetrating region LT2, and the area of the second penetrating region LT2 may be greater than or equal to an area of the third penetrating region LT3, such that a ratio of the area of the first penetrating region LT1 to the area of the first sub-pixel structure SS1 may be greater than or equal to a ratio of the area of the second penetrating region LT2 to the area of the second sub-pixel structure SS2, and a ratio of the area of the second penetrating region LT2 to the area of the second sub-pixel structure SS2 may be greater than or equal to a ratio of the area of the third penetrating region LT3 to the area of the third sub-pixel structure SS3, but not limited thereto.

Furthermore, the circuit component layer 140 may further include a plurality of data lines DL, wherein the data line DL is electrically connected between the switching component SW of the sub-pixel structure SS and a driving circuit, and the data line DL is configured to transmit the electrical signal (e.g., the gray level signal) related to the status of the display medium layer 130. In FIG. 1, the data line DL may substantially extend along the direction Y, the data line DL may be disposed on a side of the column formed of the sub-pixel structures SS, and the data line DL may not overlap the sub-pixel structure SS in the direction Z. In FIG. 1, since the geometric shape of the sub-pixel structure SS is not a quadrilateral, and the geometric shapes of two adjacent sub-pixel structures SS are opposite in the top view, the data line DL may be a zigzagging conductive line and not overlap the sub-pixel structure SS in the direction Z. For instance, the data line DL may include a plurality of zigzagging repeating units connected to each other in the direction Y, so as to make the data line DL be zigzagging, but not limited thereto.

The circuit component layer 140 may further include a plurality of scan lines (not shown in figures), wherein the scan line is electrically connected between the switching component SW of the sub-pixel structure SS and the driving circuit, and the scan line is configured to transmit a switching signal for turning on or turning off the switching component SW. In FIG. 1, the scan line may substantially extend along the direction X, and the scan line may overlap or not overlap the sub-pixel structure SS in the direction Z based on requirement(s). For instance, in the structure shown in FIG. 1, the scan line may extend along the direction X, the scan line may be disposed on a side of the row formed of the sub-pixel structures SS, and the scan line may not overlap the sub-pixel structure SS in the direction Z, but not limited thereto. For instance, the scan line may be disposed between two adjacent rows formed of the sub-pixel structures SS, and the scan line may be electrically connected to the switching components SW of the sub-pixel structures SS in these two adjacent rows, wherein since these sub-pixel structures SS are not regular rectangles, the arrangement of the switching components SW is corresponding changed, and the scan line zigzags in the direction X, but not limited thereto.

In the present invention, the display device 100 may further include other suitable layer(s), component(s) and/or structure(s) based on requirement(s). In some embodiments (as shown in FIG. 2), the display device 100 may further include a color conversion layer 150 disposed between the first substrate 110 and the second substrate 120. For instance (as shown in FIG. 2), the color conversion layer 150 may be disposed between the second substrate 120 and the display medium layer 130. For instance, the color conversion layer 150 may include color filter, fluorescence material, phosphorescence material, quantum dots (QD) material, other suitable material(s) or a combination thereof. In FIG. 2, the color conversion layer 150 may include a plurality of color converting parts 152, wherein each of the color converting parts 152 may be corresponding to one sub-pixel SP, and the color converting parts 152 may perform different color conversions based on requirement(s). For instance (as shown in FIG. 2), the color conversion layer 150 may include a first color converting part (one color converting part 152) disposed in the green sub-pixel SP1, a second color converting part (another color converting part 152) disposed in the red sub-pixel SP2 and a third color converting part (still another color converting part 152) disposed in the blue sub-pixel SP3, but not limited thereto. For instance (as shown in FIG. 2), in the direction Z, the first color converting part may be corresponding to the first reflecting region LR1 of the first sub-pixel structure SS1 in the green sub-pixel SP1, the second color converting part may be corresponding to the second reflecting region LR2 of the second sub-pixel structure SS2 in the red sub-pixel SP2, and the third color converting part may be corresponding to the third reflecting region LR3 of the third sub-pixel structure SS3 in the blue sub-pixel SP3, but not limited thereto.

In some embodiments, the display device 100 may further include a light shielding layer (not shown in figures) disposed between the first substrate 110 and the second substrate 120, wherein the light shielding layer may be configured to shield some components (e.g., opaque components or opaque traces) or regions with poor display effect in the display device 100. In some embodiments, the light shielding layer may be further configured to separate the sub-pixels SP and/or to separate the color converting parts 152 in the color conversion layer 150. For instance, the light shielding layer may include black photoresist, black ink, black resin, black pigment, metal, other suitable material(s) or a combination thereof. For instance, the light shielding layer may be disposed between the first substrate 110 and the display medium layer 130 or be disposed between the second substrate 120 and the display medium layer 130, but not limited thereto.

In the present invention, the first substrate 110 and the structures between the first substrate 110 and the display medium layer 130 may form an array substrate AS, the second substrate 120 and the structures between the second substrate 120 and the display medium layer 130 may form an opposite substrate OS, the array substrate AS and the opposite substrate OS may be opposite to each other, and the display medium layer 130 may be disposed between the array substrate AS and the opposite substrate OS. For instance (as shown in FIG. 2), the array substrate AS may include the first substrate 110 and the circuit component layer 140 (the sub-pixel structures SS, the data lines DL, the scan lines, etc.), and the opposite substrate OS may include the second substrate 120, the color conversion layer 150 and the transparent conductive layer TCL, but not limited thereto.

In addition, the display device 100 may further include the backlight module (not shown in figures) configured to provide the backlight BL, wherein the array substrate AS (the first substrate 110) may be disposed between the backlight module and the opposite substrate OS (the second substrate 120). As shown in FIG. 2, the backlight BL provided from the backlight module may pass through the penetrated region LT and not pass through the reflecting region LR.

In the displaying process of the display device 100, as shown in FIG. 2, the external light Lo may be reflected by the light reflective layer RL in the reflecting region LR of the sub-pixel structure SS to form a reflecting light Lf, the backlight BL provided from the backlight module may pass through the penetrated region LT of the sub-pixel structure SS to form a penetrating light, and the display device 100 may display an image through the reflecting light Lf and the penetrating light. In FIG. 2, the external light Lo may enter the display device 100 from a side of the opposite substrate OS opposite to the light reflective layer RL (i.e., the top side shown in FIG. 2), and the external light Lo may be reflected by the light reflective layer RL in the reflecting region LR of the sub-pixel structure SS to form the reflecting light Lf after passing through the opposite substrate OS and the display medium layer 130 in sequence. Then, the reflecting light Lf may pass through the display medium layer 130 and the opposite substrate OS in sequence, and finally exit the display device 100 for displaying. In FIG. 2, the backlight BL of the backlight module may enter the array substrate AS from a side of the array substrate AS opposite to the opposite substrate OS (i.e., the bottom side of FIG. 2), the backlight BL may pass through the array substrate AS (i.e., the penetrated region LT of the sub-pixel structure SS), the display medium layer 130 and the opposite substrate OS in sequence and finally exit the display device 100 to form the penetrating light, thereby enhancing the brightness of the display image. Since the status of the display medium layer 130 may be adjusted to affect the light transmittance of the sub-pixel SP according to the electrical signal (e.g., the gray level signal) received by the corresponding sub-pixel structure SS, the reflecting light Lf and the penetrating light emitted from the display device 100 may have the intensities corresponding to the electrical signal (e.g., the gray level signal) received by the corresponding sub-pixel structure SS due to the influence of the light transmittance of the corresponding sub-pixel SP, thereby displaying an image.

The array substrate and the display device of the present invention are not limited to the above embodiments. Further embodiments of the present invention are described below. For ease of comparison, same components will be labeled with the same symbol in the following. The following descriptions relate the differences between each of the embodiments, and repeated parts will not be redundantly described.

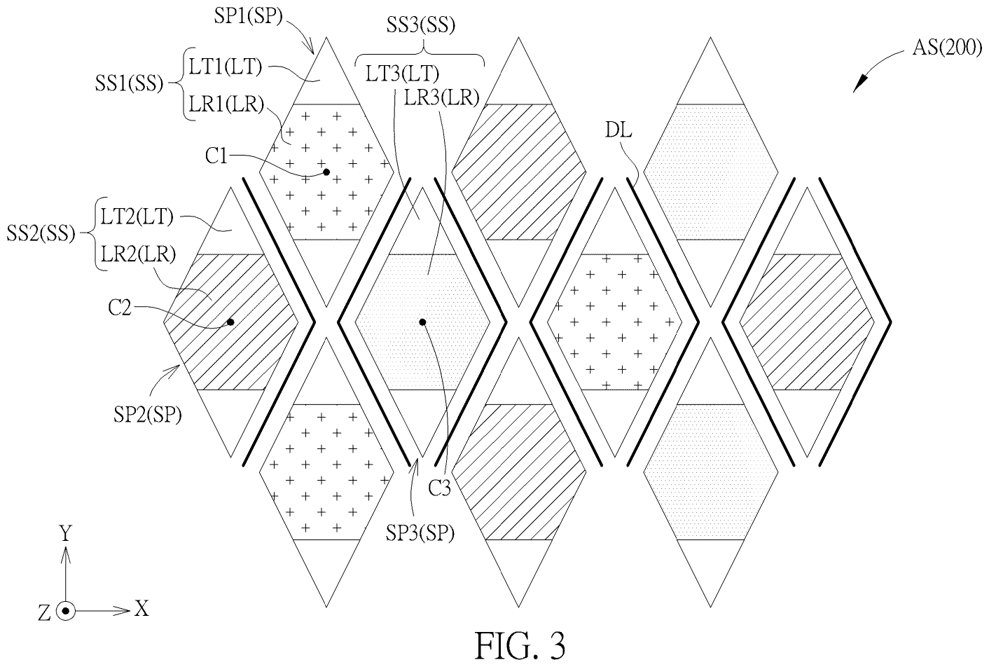

Referring to FIG. 3, FIG. 3 is a schematic diagram of a top view illustrating sub-pixel structures of a display device according to a second embodiment of the present invention. As shown in FIG. 3, a difference between this embodiment and the first embodiment is that the design of the sub-pixel structure SS of the display device 200 of this embodiment. In FIG. 3, each sub-pixel structure SS may include one reflecting region LR and a plurality of penetrated regions LT. For instance, each sub-pixel structure SS may include one reflecting region LR and two penetrated regions LT, and the reflecting region LR may be disposed between two penetrated regions LT, but not limited thereto.

Moreover, in FIG. 3, the geometric shape of the sub-pixel structure SS, the geometric shape of the reflecting region LR and the geometric shape of the penetrated region LT in the top view have a design other than the first embodiment. For instance, the geometric shape of the sub-pixel structure SS may be a rhombus, the geometric shape of the reflecting region LR may be a hexagon, and the geometric shape of the penetrated region LT may be a triangle, but not limited thereto. For instance, in FIG. 3, the geometric shape of the sub-pixel structure SS may be a rhombus and have four vertices, two vertices of the sub-pixel structure SS are situated in the reflecting region LR, and other two vertices of the sub-pixel structure SS are situated in the penetrated regions LT, but not limited thereto.

In FIG. 3, two adjacent sub-pixel structures SS (i.e., two sub-pixel structures SS closest to each other) may be misaligned in the horizontal direction (e.g., the direction X and/or the direction Y), such that two adjacent sub-pixel structures SS may be partially corresponding to each other in the direction X. Therefore, in one pixel, the first center C1 of the first sub-pixel structure SS1, the second center C2 of the second sub-pixel structure SS2 and the third center C3 of the third sub-pixel structure SS3 may form a triangle in the top view (i.e., the first center C1, the second center C2 and the third center C3 are three vertices of a triangle), such that the first sub-pixel structure SS1, the second sub-pixel structure SS2 and the third sub-pixel structure SS3 may be arranged in a triangular manner, so as to increase the tightness of the sub-pixel structures SS, thereby enhancing the display quality.

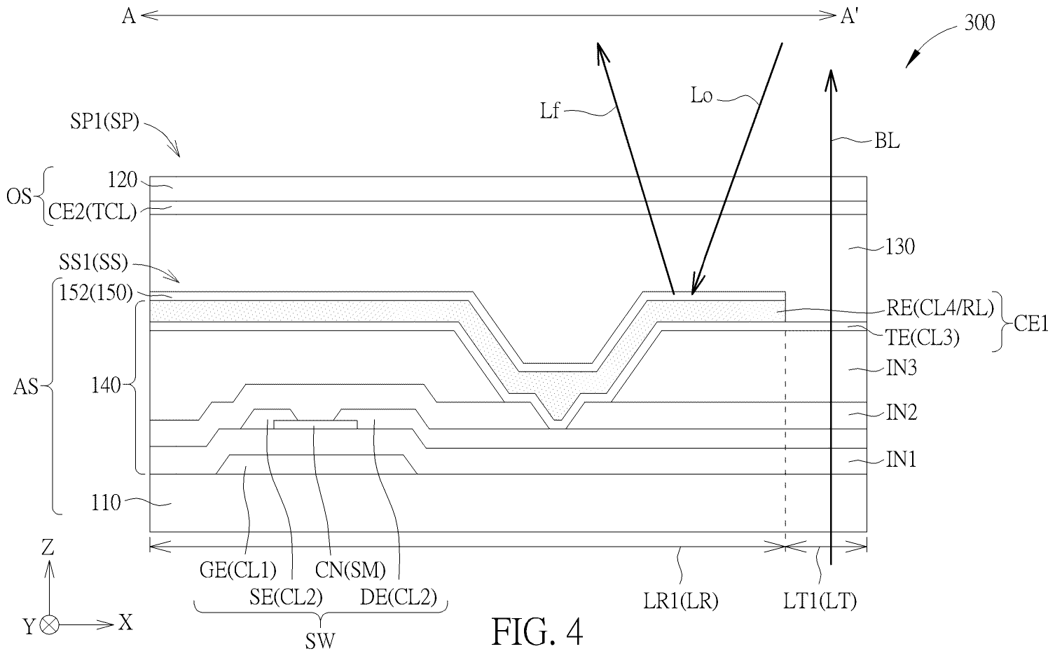

Referring to FIG. 4, FIG. 4 is a schematic diagram of a cross-sectional view illustrating a display device according to a third embodiment of the present invention. As shown in FIG. 4, a difference between this embodiment and the first embodiment is that the design of the color conversion layer 150 of the display device 300 of this embodiment. The color conversion layer 150 may be disposed between the first substrate 110 and the display medium layer 130, such that the color conversion layer 150 may belong to the array substrate AS, and the color converting part 152 of the color conversion layer 150 is a structure belonging to the sub-pixel structure SS. The position of the color conversion layer 150 shown in FIG. 4 is an example, and the color conversion layer 150 of another example may be a layer disposed on the first substrate 110 and at suitable position. In some embodiments, the first sub-pixel structure SS1 may include the first color converting part (one color converting part 152) disposed in the first reflecting region LR1, the second sub-pixel structure SS2 may include the second color converting part (another color converting part 152) disposed in the second reflecting region LR2, and the third sub-pixel structure SS3 may include the third color converting part (still another color converting part 152) disposed in the third reflecting region LR3, but not limited thereto. In this embodiment, the boundaries of the reflecting region LR may be defined by the reflecting electrode RE and/or the color converting part 152.

In summary, in the present invention, the geometric shape of the sub-pixel structure, the geometric shape of the reflecting region and the geometric shape of the penetrated region in the top view are suitably designed, so as to increase the tightness of the sub-pixel structure of the display device, thereby enhancing the display quality of the display device. Furthermore, since the sub-pixel structure of the display device of the present invention has the penetrated region capable of making the backlight pass through, the brightness of the display image is enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An array substrate, comprising:
a first substrate; and
a plurality of sub-pixel structures disposed on the first substrate, wherein the sub-pixel structures comprise:
a first sub-pixel structure having a first center and comprising a first reflecting region and at least one first penetrating region;
a second sub-pixel structure having a second center and comprising a second reflecting region; and
a third sub-pixel structure having a third center and comprising a third reflecting region;
wherein the first sub-pixel structure, the second sub-pixel structure and the third sub-pixel structure are adjacent to each other and display different colors, and the first center, the second center and the third center form a triangle in a top view;
wherein at least two of a geometric shape of the first sub-pixel structure, a geometric shape of the first reflecting region and a geometric shape of the first penetrating region are not quadrilaterals.

2. The array substrate according to claim 1, wherein one of the geometric shape of the first sub-pixel structure, the geometric shape of the first reflecting region and the geometric shape of the first penetrating region is a quadrilateral and is not a rectangle.

3. The array substrate according to claim 1, wherein the geometric shape of the first sub-pixel structure, the geometric shape of the first reflecting region and the geometric shape of the first penetrating region have symmetrical axes.

4. The array substrate according to claim 1, wherein the geometric shape of the first sub-pixel structure is a triangle, a quadrilateral or a hexagon, the geometric shape of the first reflecting region is a triangle, a quadrilateral or a hexagon, and the geometric shape of the first penetrating region is a triangle, a quadrilateral or a hexagon.

5. The array substrate according to claim 1, wherein the geometric shape of the first reflecting region is different from the geometric shape of the first penetrating region.

6. The array substrate according to claim 1, wherein a vertex of the first sub-pixel structure is situated in the first penetrating region.

7. The array substrate according to claim 1, wherein a ratio of an area of the first penetrating region to an area of the first sub-pixel structure is greater than 0 and less than or equal to 0.55.

8. The array substrate according to claim 1,
wherein the second sub-pixel structure further comprises at least one second penetrating region, and at least two of a geometric shape of the second sub-pixel structure, a geometric shape of the second reflecting region and a geometric shape of the second penetrating region are not quadrilaterals;
wherein the third sub-pixel structure further comprises at least one third penetrating region, and at least two of a geometric shape of the third sub-pixel structure, a geometric shape of the third reflecting region and a geometric shape of the third penetrating region are not quadrilaterals.

9. The array substrate according to claim 8, wherein the first sub-pixel structure is disposed between the second sub-pixel structure and the third sub-pixel structure, the second penetrating region, the first reflecting region and the third penetrating region are arranged in a direction, and the second reflecting region, the first penetrating region and the third reflecting region are arranged in the direction.

10. The array substrate according to claim 1, wherein the first sub-pixel structure comprises a first reflecting electrode disposed in the first reflecting region and defining the first reflecting region, the second sub-pixel structure comprises a second reflecting electrode disposed in the second reflecting region and defining the second reflecting region, and the third sub-pixel structure comprises a third reflecting electrode disposed in the third reflecting region and defining the third reflecting region.

11. The array substrate according to claim 1, wherein the first sub-pixel structure comprises a first color converting part disposed in the first reflecting region, the second sub-pixel structure comprises a second color converting part disposed in the second reflecting region, and the third sub-pixel structure comprises a third color converting part disposed in the third reflecting region.

12. The array substrate according to claim 1, wherein the first sub-pixel structure comprises a pixel electrode disposed in the first penetrating region.

13. The array substrate according to claim 1, further comprising a plurality of data lines disposed on the first substrate, wherein the data lines substantially extend along a first direction, and each of the data lines comprises a plurality of zigzagging repeating units connected to each other in the first direction.

14. The array substrate according to claim 13, wherein the sub-pixel structures do not overlap the data lines in a top-view direction.

15. The array substrate according to claim 13, further comprising a plurality of scan lines disposed on the first substrate, wherein the scan lines substantially extend along a second direction, and each of the scan lines zigzags in the second direction.

16. A display device, comprising:
an array substrate, comprising:
a first substrate; and
a plurality of sub-pixel structures disposed on the first substrate, wherein the sub-pixel structures comprise:
a first sub-pixel structure having a first center and comprising a first reflecting region and at least one first penetrating region;
a second sub-pixel structure having a second center and comprising a second reflecting region; and
a third sub-pixel structure having a third center and comprising a third reflecting region;
an opposite substrate opposite to the array substrate; and
a display medium layer disposed between the array substrate and the opposite substrate;
wherein the first sub-pixel structure, the second sub-pixel structure and the third sub-pixel structure are adjacent to each other and display different colors, and the first center, the second center and the third center are three vertices of a triangle;
wherein at least two of a geometric shape of the first sub-pixel structure, a geometric shape of the first reflecting region and a geometric shape of the first penetrating region are not quadrilaterals.

17. The display device according to claim 16, wherein each of the first reflecting region, the second reflecting region and the third reflecting region has a reflecting electrode for displaying.

18. The display device according to claim 16, further comprising a backlight module, wherein the array substrate is disposed between the backlight module and the opposite substrate.

19. The display device according to claim 18, wherein a light provided from the backlight module passes through the first penetrating region and does not pass through the first reflecting region.

20. The display device according to claim 16, wherein the display device a transflective display.
